(19) United States
(12) Patent Application Publication
(10) Pub. No.: US 2015/0116643 A1
(43) Pub. Date: Apr. 30, 2015

(54) DISPLAY DEVICE AND METHOD FOR MANUFACTURING THE SAME

(71) Applicant: Samsung Display Co., Ltd., Yongin-city (KR)

(72) Inventors: Duckjong SUH, Seoul (KR); Hyunku Ahn, Hwaseong-si (KR); Gak Seok Lee, Hwaseong-si (KR); Taekjoon Lee, Hwaseong-si (KR); Seungyeon Jeong, Hwaseong-si (KR); Hyeon Gu Cho, Yongin-si (KR); Jaejin Lyu, Yongin-si (KR)

(73) Assignee: Samsung Display Co., Ltd., Yongin-city (KR)

(21) Appl. No.: 14/251,387

(22) Filed: Apr. 11, 2014

(30) Foreign Application Priority Data
Oct. 24, 2013 (KR) 10-2013-0127426

(51) Int. Cl. G02F 1/1337

(52) U.S. Cl. CPC G02F 1/133788
USPC 349/123; 445/24

(57) ABSTRACT

A display device includes two facing substrates, a liquid crystal layer provided between the two substrates, and alignment layers provided between the liquid crystal layer and each of the substrates. The alignment layer includes a main layer, and an alignment forming layer provided on the main layer and including a plurality of domains phase separated from the main layer.

### CROSS REFERENCE TO RELATED APPLICATION

This application claims priority from and the benefit of Korean Patent Application No. 10-2013-0127426, filed on Oct. 24, 2013, which is hereby incorporated by reference for all purposes as if fully set forth herein.

### BACKGROUND

1. Field

Exemplary embodiments of the present invention relate to a display device including an alignment layer for aligning liquid crystal molecules and a method for manufacturing the same.

2. Discussion of the Background

Generally, a liquid crystal display device may be classified as a twisted nematic (TN) liquid crystal display device, an in-plane switching (IPS) mode liquid crystal display device, or a vertical alignment (VA) mode liquid crystal display device, according to the properties of a liquid crystal layer.

In the vertical alignment (VA) mode liquid crystal display device, in the absence of electric field application, the major axes of the liquid crystal molecules are aligned in a vertical direction with respect to the surface of a substrate. Accordingly, a viewing angle of a vertical alignment mode liquid crystal display is wide and the contrast ratio is large.

Rubbing methods or photo alignment methods may be used to align liquid crystal molecules in a certain direction. In the vertical alignment mode liquid crystal display device, the liquid crystal molecules may be aligned by using a reactive mesogen, according to one method of photo alignment. The reactive mesogen is disposed in an uncured state in a liquid crystal layer and becomes cured when exposed to light, to align the liquid crystal molecules.

### SUMMARY

Exemplary embodiments of the present invention provide a method for manufacturing a display device including a forming method of an alignment layer effectively pretilting liquid crystal molecules.

Exemplary embodiments of present invention also provide a display device manufactured by the above-described method and having improved display quality.

Additional features of the invention will be set forth in the description which follows, and in part will be apparent from the description, or may be learned by practice of the invention.

An exemplary embodiment of the present invention discloses liquid crystal display devices including two substrates facing each other, a liquid crystal layer disposed between the two substrates, and alignment layers disposed between the liquid crystal layer and each of the substrates. The alignment layer includes a main layer and an alignment-forming layer disposed on the main layer. The alignment layer further includes a plurality of domains that are phase-separated from the main layer.

An exemplary embodiment of the present invention also discloses methods for manufacturing a liquid crystal display device including forming a liquid crystal layer between two substrates, each substrate including an initial alignment layer, and exposing the alignment layer by applying an electric field and light to the initial alignment layer. The forming of the initial alignment layer on each substrate includes coating an alignment solution on the substrate, pre-curing the alignment solution to form a main layer and an alignment-forming layer provided on the main layer and including a plurality of domains phase separated from the main layer, and curing the main layer and the alignment forming layer.

According to an embodiment of the inventive concept, an alignment layer capable of effectively pretilting liquid crystal molecules is provided. Thus, a display device having improved display quality is provided.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept.

FIG. 1 is a cross-sectional view illustrating a liquid crystal display device according to an embodiment of the inventive concept.

FIG. 2A is a plan view illustrating the top surface of an alignment layer in a liquid crystal display device according to an embodiment of the inventive concept.

FIGS. 2B and 2C are cross-sectional views taken along line I-I′ in FIG. 2A.

FIG. 3 is a flowchart illustrating a method for manufacturing a liquid crystal display device according to an embodiment of the inventive concept.

FIG. 4 is a flowchart illustrating a method for forming an initial alignment layer.

FIG. 5 is a graph illustrating the receding contact angles of initial alignment layers with respect to pre-curing temperatures.

FIG. 6 is a graph illustrating the area ratios of domains with respect to pre-curing temperatures.

FIG. 7 is a graph illustrating pretilt angles with respect to pre-curing temperatures.

FIG. 8 is a graph illustrating receding contact angles of initial alignment layers with respect to the thicknesses of initial alignment layers.

FIG. 9 is a graph illustrating the area ratios of domains with respect to the thicknesses of initial alignment layers.

FIG. 10 is a graph illustrating pretilt angles with respect to the thicknesses of initial alignment layers.

FIGS. 11A, 11B, 11C, and 11D are the photographs of alignment layers having different areas of alignment.

### DETAILED DESCRIPTION OF THE ILLUSTRATED EMBODIMENTS

Exemplary embodiments of the inventive concept will be described below in more detail with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art.

In the drawings, like reference numerals refer to like elements throughout and the dimensions of layers and regions are exaggerated for clarity of illustration. It will be understood that, although the terms first, second, etc. may be used herein to describe various elements and should not be limited by these terms. These terms are only used to distinguish one element from another element. Thus, a first element discussed below could be termed a second element, and similarly, a second element could be termed a first element. The singular forms “a,” “an” and “the” are intended to include the plural forms as well, unless the context clearly indicates otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when a layer, a film, a region, a plate, etc. is referred to as being ‘on’ or ‘connected to’ another layer, film, region, plate, etc., it can be directly on or connected to the other layer, film, region, plate, etc., or intervening elements may also be present. Further, it will be understood that when a layer, a film, a region, a plate, etc. is referred to as being ‘under’ another layer, film, region, plate, etc., it can be directly under, and one or more intervening elements may also be present.

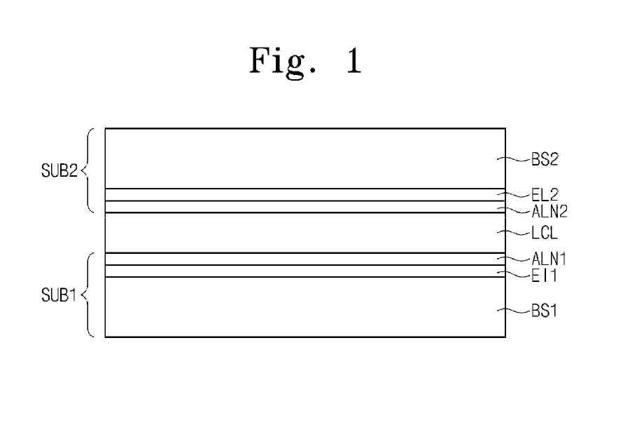

FIG. 1 is a cross-sectional view schematically illustrating a liquid crystal display device according to an embodiment of the inventive concept.

Referring to FIG. 1, the liquid crystal display device includes a first substrate SUB1, a second substrate SUB2 facing the first substrate SUB1, and a liquid crystal layer LCL formed between the first substrate SUB1 and the second substrate SUB2.

The first substrate SUB1 includes a first base substrate BS1, a first electrode EL1 disposed on the first base substrate BS1, and a first alignment layer ALN1 disposed on the first electrode EL1.

The first base substrate BS1 may include a transparent insulating substrate, such as glass, quartz, plastic, and/or another appropriate material, and may have a rectangular shape having a pair of parallel planar surfaces. The first base substrate BS1 may have a rectangular shape including a pair of long sides and a pair of short sides.

The first electrode EL1 may include transparent conductive material. Particularly, the first electrode EL1 may be formed using a transparent conductive oxide. The transparent conductive oxide may include indium tin oxide (ITO), indium zinc oxide (IZO), indium tin zinc oxide (ITZO), and/or other appropriate materials.

Even though not illustrated, signal wiring such as a gate line, a data line, a storage line, and the like, and a thin film transistor connected to the signal wiring and switching a voltage application to the first electrode EL1 may be disposed on the first base substrate BS1.

The first alignment layer ALN1 is disposed on the first electrode EL1 and pretilts liquid crystal molecules in a liquid crystal layer LCL.

The second substrate SUB2 includes a second base substrate BS2, a second electrode EL2 provided on the second base substrate BS2, and a second alignment layer ALN2 provided on the second electrode EL2.

The second substrate BS2 faces the first base substrate BS1. The second base substrate BS2 may be a transparent insulating substrate like the first base substrate BS1 and may include glass, quartz, plastic, and/or another appropriate material. The second base substrate BS2 may be provided with a substantially the same shape as the first base substrate BS1. However, the second base substrate BS2 may have a smaller area than the first base substrate BS1.

The second electrode EL2 is disposed on the second base substrate BS2 and drives the liquid crystal layer LCL by forming an electric field in conjunction with the first electrode EL1. The second electrode EL2 may be formed by using a transparent conductive material including a conductive metal oxide such as ITO, IZO, ITZO, and other appropriate materials.

The second alignment layer ALN2 is disposed on the second electrode EL2 and pretilts liquid crystal molecules in the liquid crystal layer LCL.

The liquid crystal layer LCL, including liquid crystal molecules is disposed between the first substrate SUB1 and the second substrate SUB2.

In the liquid crystal display device, when an electric field is formed between the first electrode E and the second electrode EL2, by an applied voltage to the second electrode EL2 and the first electrode EL1 the liquid crystal molecules are driven by the electric field. In this manner, the amount of light penetrating the liquid crystal layer LCL may be changed and an image may be displayed.

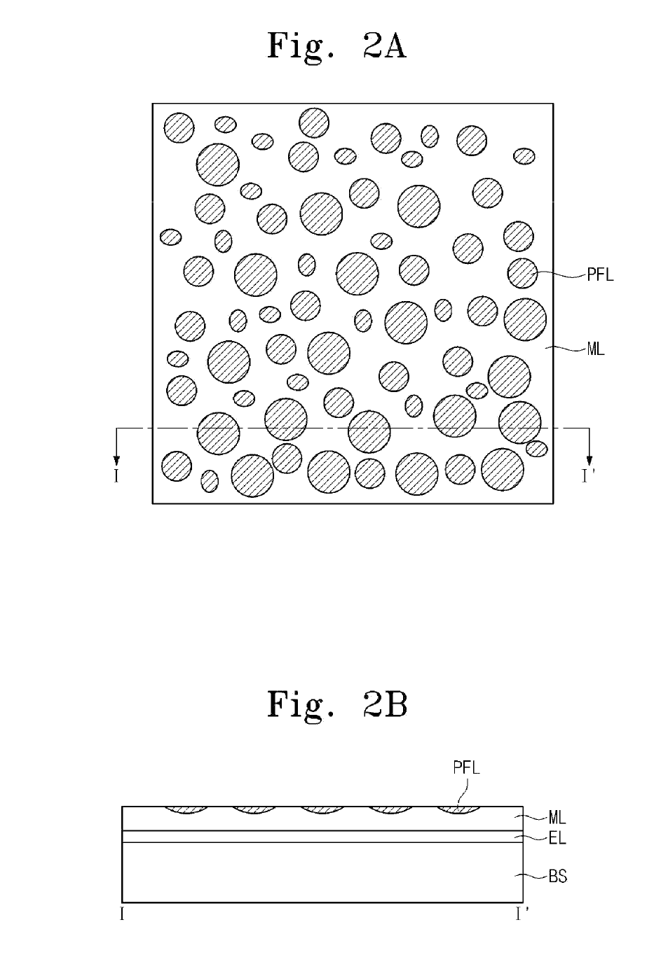

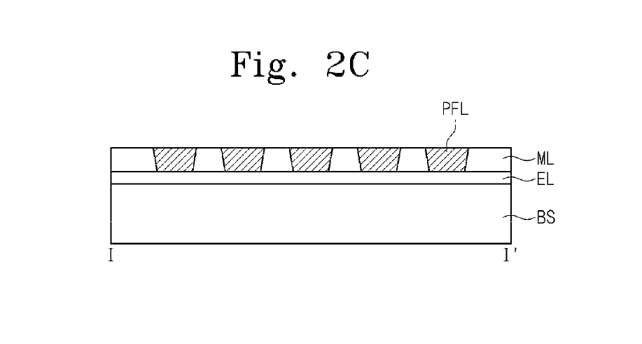

Hereinafter, the first alignment layer ALN1 and the second alignment layer ALN2 will be described in detail with reference to FIGS. 2A, 2B, and 2C. The first alignment layer ALN1 and the second alignment layer ALN2 have substantially the same structure and so, an “alignment layer” will be explained without further distinction. In the same manner, the first base substrate BS1 and the second base substrate BS2 will now be described together as “substrate BS” and the first electrode EL1 and the second electrode EL2 will be described together as “electrode EL”.

FIG. 2A is a plan view illustrating the top surface of an alignment layer in a liquid crystal display device, FIG. 2B is a cross-sectional view taken along line I-I′ in FIG. 2A in a liquid crystal display device, and FIG. 2C is a cross-sectional view taken along line I-I′ in FIG. 2A in a liquid crystal display device according to another embodiment of the inventive concept.

Referring to FIGS. 2A, 2B, and 2C, an electrode EL is formed on a substrate BS, and an alignment layer is formed on the electrode EL. The alignment layer includes a main layer ML and an alignment forming layer PFL disposed on the main layer ML.

The main layer ML is disposed on the substrate BS to cover most of the substrate BS. The main layer ML may include a polymer such as polyimide, polyamic acid, polyamide, polyamic imide, polyester, polyethylene, polyurethane, or polystyrene, and/or a polymer including a mixture thereof, as a main chain.

In the main layer ML, a side chain having a vertical alignment group vertically aligning the liquid crystal molecules may be included. The vertical alignment group aligns the liquid crystal molecules vertically and is not limited specifically. The vertical alignment group may include, for example, an alkyl group having 1 to 25 carbon atoms. In an embodiment of the inventive concept, the vertical alignment group may include at least one of an alkoxy group including an aliphatic alkyl group having 1 to 25 carbon atoms, a cholesteric group, an alicyclic group including an aliphatic alkyl group having 3 to 16 carbon atoms, and an aromatic group including an aliphatic alkyl group having 3 to 16 carbon atoms. In an embodiment of the inventive concept, the alkoxy group including the aliphatic alkyl group may include

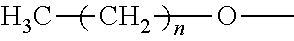

(where n is 5 to 18). The aromatic group including the aliphatic alkyl group may include

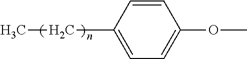

(where n is 3 to 16).

The main layer ML may be more hydrophilic than the alignment forming layer PFL. When the main layer ML includes a polymer, a receding contact angle with respect to water on the polymer may be less than or equal to about 40°, for example, about 33°. Here, the receding contact angle is a contact angle measured by using a measuring method of a dynamic contact angle. The dynamic contact angle may include an advancing contact angle, a measurement of which may be obtained by dropping water drops on an initial alignment layer with a pipe, and measuring the angle between the initial alignment layer and the water droplets. The dynamic contact angle may further include a receding contact angle, a measurement of which may be obtained by removing water with a pipe and measuring the angle between the initial alignment layer and the water droplets. Both of the advancing contact angle and the receding contact angle may increase when the hydrophobicity of the initial alignment layer increases.

The alignment forming layer PFL forms a plurality of domains in a portion of the main layer ML and pretilts liquid crystal molecules. As illustrated in FIG. 2B, the plurality of domains may be formed on the top surface of the main layer ML. In this case, the domains may form an interface with the main layer ML and may be separated from the electrode EL by the main layer ML disposed therebetween.

In another embodiment of the inventive concept, as illustrated in FIG. 2C, the plurality of domains may be formed so as to penetrate the main layer ML. In this case, the domains may interface with the main layer ML and the electrode EL simultaneously. The domains correspond to the hatched areas in FIGS. 2A, 2B and 2C.

The alignment forming layer PFL may include a polymer such as polyimide, polyamic acid, polyamide, polyamic imide, polyester, polyethylene, polyurethane, or polystyrene, or a polymer including a mixture thereof as a main chain, and may include a polymerized reactive mesogen as a side chain for pretilting the liquid crystal molecules. The reactive mesogen is a functional group that generates a polymerization reaction when receiving energy such as ultraviolet light to form a side chain.

The alignment forming layer PFL may not be completely distinct from the main layer ML, and may be connected with at least a portion of the main layer ML through a network. The alignment forming layer PFL corresponds to a region in which side chains composed of the reactive mesogen are provided in high concentration. Particularly, the polymerized reactive mesogen is provided in markedly high concentration in the domains, and each of the domains corresponds to a reactive mesogen-rich area. The exposed surface area of the alignment forming layer PFL, with respect to the total exposed surface area of the alignment layer may be greater than or equal to about 5%, to sufficiently pretilt liquid crystal molecules.

The reactive mesogen may include at least one among an acrylate group, a methacrylate group, an epoxy group, an oxetane group, a vinyl-ether group, a styrene group and a thiolane group. The reactive mesogen may be polymerized by the polymerization reaction and may pretilt the liquid crystal molecules so as to have a predetermined angle of inclination with respect to one side of the substrate BS.

The reactive mesogen may be selected from the compounds represented by the following Formula 1.

P1-Sp1-A1-Sp2-(A2)m-Sp3-A3-Sp4-P2 [Formula 1]

In Formula 1, P1 is a terminal group including 1 to 7 reactive groups causing a polymerization reaction. The reactive group may induce the polymerization reaction and may include, for example, an acrylate group, a methacrylate group, an epoxy group, an oxetane group, a vinyl-ether group, a styrene group and/or a thiolane group. P2 is a terminal group including 1 to 7 reactive groups causing a polymerization reaction and is provided independently from P1. The reactive group may induce the polymerization reaction and may include, for example, an acrylate group, a methacrylate group, an epoxy group, an oxetane group, a vinyl-ether group, a styrene group, and/or a thiolane group.

Each of Sp1, Sp2, Sp3 and Sp4 independently is at least one among a single bond, —CH₂—, —COO—, —CO—CH═CH—, —COO—CH═CH—, —CH₂OCH₂— and —CH₂O—.

Each of A1 and A3 independently represents at least one among a single bond, a cyclohexyl group, a phenyl group, a thiophenyl group, and a polycyclic aromatic group, or a derivative thereof substituted by 0 to 10 of —F, —Cl, —OCH₃, and an alkyl group having 1 to 6 carbon atoms.

A2 is at least one among a cyclohexyl group, a phenyl group, a thiophenyl group and a polycyclic aromatic hydrocarbon group, or a derivative thereof substituted by 0 to 10 of —F, —Cl, —OCH₃, and an alkyl group having 1 to 6 carbon atoms.

In Formula 1, m is a natural number between 1 and 4.

A single type of the reactive mesogen may be used or two or more types of the reactive mesogens may be used. For example, one or two of the reactive mesogens represented by the following Formulae 2 and 3 may be used. In the following Formula 3, n is a natural number between 1 and 12.

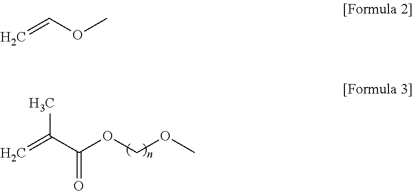

The alignment forming layer PFL may further include a vertical alignment group to vertically align the liquid crystal molecules. The vertical alignment group aligns the liquid crystal molecules vertically and is not specifically limited. For example, the vertical alignment group may include, for example, an alkyl group having 1 to 25 carbon atoms.

The reactive mesogen may include at least one of an alkoxy group including an aliphatic alkyl group having 1 to 25 carbon atoms, a cholesteric group, an alicyclic group including an aliphatic alkyl group having 3 to 16 carbon atoms, and an aromatic group including an aliphatic alkyl group having 3 to 16 carbon atoms. The alkoxy group including the aliphatic alkyl group may include

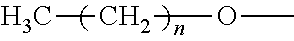

(where n is a natural number between 5 and 18). The aromatic group including the aliphatic alkyl group may include

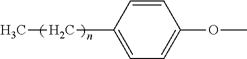

(where n is a natural number between 3 and 16).

Here, the vertical alignment group of the main layer ML and the vertical alignment group of the alignment forming layer PFL may be the same or different. For example, the vertical alignment group of the main layer ML may be a cholesteric group, and the vertical alignment group of the alignment forming layer PFL may be an alkoxy group having an aliphatic alkyl group having 3 to 16 carbon atoms.

The alignment forming layer PFL is more hydrophobic than the main layer ML. The receding contact angle of the alignment forming layer PFL with respect to water is greater than or equal to about 60°, for example about 66°.

The alignment forming layer PFL may be disposed on the main layer ML and may be thinner than the main layer ML. Each of the domains formed by the alignment forming layer PFL may a circular region, an elliptical region, or a closed region formed by a closed curve similar to a circle or an ellipse; that is, an island shape. The mean diameter of each domain may be less than or equal to about 1 μm. For example, the mean diameter of each domain may be less than or equal to about 400 nm. Alternatively, a bi-continuous shape in which two phases are continuously arranged may be formed. Each of the domains may include the closed region formed by the closed curve, and may include a connection between adjacent closed regions.

From a plan view, the region in which the alignment forming layer PFL is not formed is the exposed region of the main layer ML. The area of the alignment forming layer PFL with respect to the top surface of the main layer ML may be changed according to the manufacturing process.

In FIGS. 2A and 2B, the top surface of the main layer ML and the exposed top surface of the alignment forming layer PFL are shown on one plane. However, the inventive concept is not limited thereto. According to the forming conditions of the alignment forming layer PFL or the type and the component ratio of the reactive mesogen, the surface of the alignment forming layer PFL may be higher or lower than the exposed surface of the main layer ML. That is, the alignment forming layer PFL may protrude above or may be disposed below the top surface of the main layer ML.

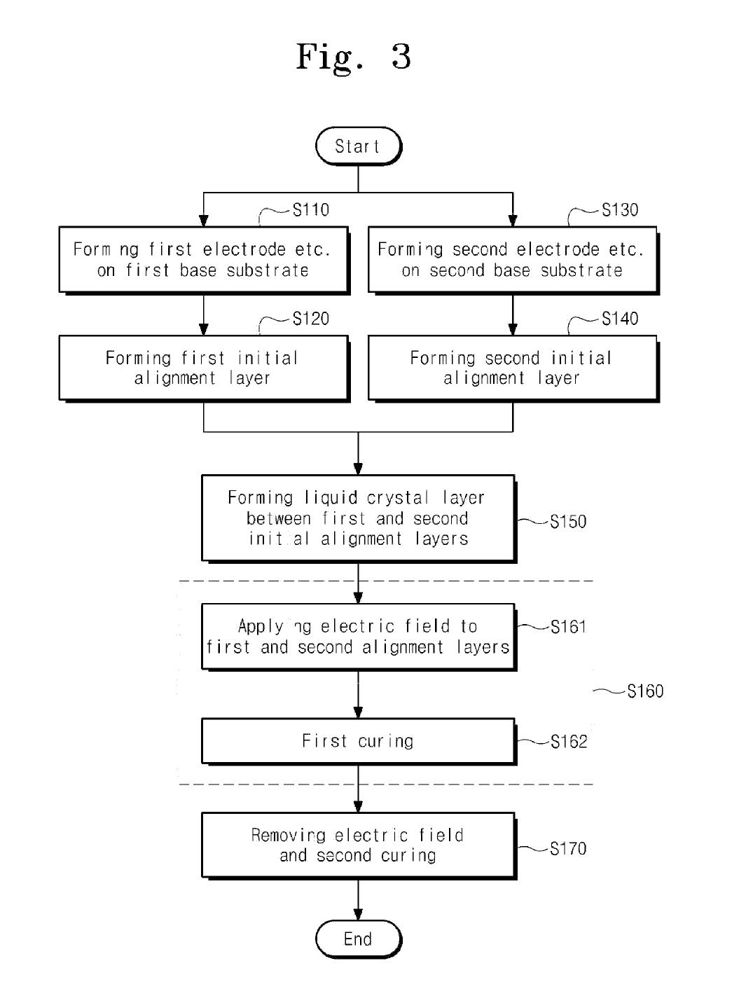

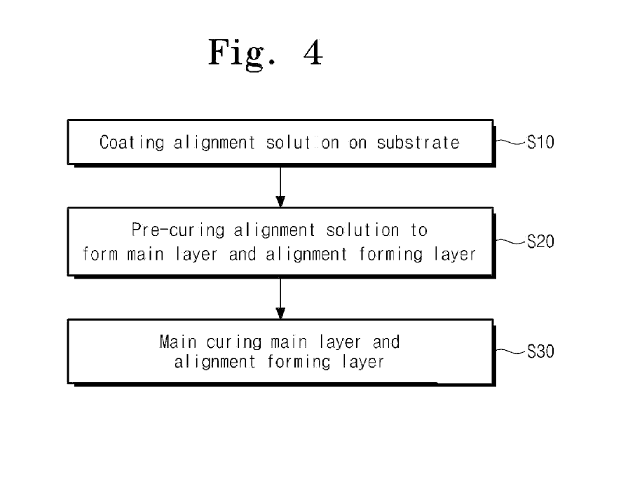

Hereinafter, a method of manufacturing a liquid crystal display device having the above-described structure will be explained. FIG. 3 is a flowchart illustrating a method for manufacturing a liquid crystal display device according to an embodiment of the inventive concept. FIG. 4 is a flowchart illustrating a method for forming an initial alignment layer.

Referring to FIGS. 3 and 4, a first electrode and other components are formed on a first base substrate (Step S110), and a first initial alignment layer is formed on the first base substrate (Step S120).

First, the first electrode is formed on the first base substrate. Even though not separately illustrated, a wiring part including a gate line, a data line, a storage line and other components, and a thin film transistor connected to the gate line and the data line may be formed between the first base substrate and the first electrode. The wiring part and the thin film transistor may be formed using a mask in a photolithography process. The first electrode may be formed by first forming a transparent conductive material and then patterning by a photolithography process.

Separate from the first substrate, a second electrode may be formed on a second base substrate (Step S130), and a second initial alignment layer is formed on the second base substrate (Step S140).

Even though not illustrated, a color filter, a black matrix, and other components may be formed between the second base substrate and the second electrode. The color filter and the black matrix, and the other components may be formed using a mask in a photolithography process. The second electrode may be formed by first forming a transparent conductive material and then patterning by a photolithography process.

The first initial alignment layer may be formed on the first base substrate including the first electrode, the second initial alignment layer may be formed on the second base substrate including the second electrode. The first initial alignment layer and the second initial alignment layer may be formed using substantially the same material by means of substantially the same method. Therefore, a method of forming an “initial alignment layer” will be explained without distinction of the two initial alignment layers referring to FIG. 4.

To form the initial alignment layer, an alignment solution is coated on a substrate (Step S10). The alignment solution may be coated on the substrate by various methods, for example, an inkjet method, a roll printing method, a slit coating method, and other such methods.

The alignment solution includes a solvent that includes a solid polymer. The solvent may be provided by from about 92 wt % to about 97 wt %, and the solid content may be provided by from about 3 wt % to about 8 wt % based on the total amount of the alignment solution.

The amounts of the solvent and the solid content may be changed according to the method of forming the alignment solution. For example, when the alignment solution is coated on the substrate by the inkjet method, the solvent may be about 97 wt % and the solid content may be about 3 wt %. In addition, when the alignment solution is coated on the substrate by the roll printing method, the solvent may be from about 92 wt % to about 95 wt % and the solid content may be from about 5 wt % to about 8 wt %.

The solid content may include a polymer and a cross-linking agent. The polymer may include polyimide, polyamic acid, polyamide, polyamic imide, polyester, polyethylene, polyurethane or polystyrene, and/or a mixture thereof. The polymer may be included by from about 90 wt % to about 97 wt %, for example, about 93.8 wt %, based on 100 wt % of the total amount of the solid content.

In the polymer, the polymer for forming the main layer may be included from about 80 wt % to about 90 wt %, and the polymer for forming the alignment forming layer may be included from about 3.8 wt % to about 10 wt %. For example, the polymer for forming the main layer may be about 85 wt %, and the polymer for forming the alignment forming layer may be about 8.3 wt %.

In the polymer for forming the main layer, the vertical alignment group may be a cholesteric group. In the polymer for forming the alignment forming layer, the reactive mesogen may be synthesized by mixing two types of the reactive mesogens represented by the above Formulae 2 and 3. The reactive mesogens of the above Formula 2 and Formula 3 may be included in a ratio of about 1:2. The vertical alignment group may be an aromatic group, including an aliphatic alkyl group having 3 to 16 carbon atoms, and may be included by an amount of about 33 wt % of the reactive mesogen. In other words, the weight ratio of the reactive mesogen of Formula 2, the reactive mesogen of Formula 3 and the vertical alignment group may be about 1:2:1.

In an embodiment of the inventive concept, the reactive mesogen and the vertical alignment group may attach to sites where the side chains are attached in the polymer for forming the alignment forming layer. The side chains may attach to the sites corresponding to about 40% to about 60% of the total sites.

The cross-linking agent may be an epoxy-based cross-linking agent. The epoxy-based cross-linking agent may combine with the polymer and may increase the hardness and the density of the surface of the alignment layer. The cross-linking agent may be included in an amount from about 3 wt % to about 10 wt % based on 100 wt % of the total amount of the solid content, for example, in an amount representing about 6.2 wt %.

The solvent may dissolve the polymer and the epoxy-based cross-linking agent so that a liquid crystal aligning agent may be coated on a substrate in a liquid state. The solvent may be at least one among γ-butyrolactone (γ-BL), ethylene glycol butyl ether (or butyl cellosolve) and N-methyl pyrrolidone, or a solution including at least two among the three solvents. However, the inventive concept is not limited thereto and various solvents other than the above-described solvents may be used.

Then, the alignment solution is pre-cured to form a main layer and an alignment forming layer provided on the main layer and including a plurality of domains phase separated from the main layer (Step S20).

During the pre-curing step at least a portion of the solution is removed. The pre-curing may be performed at a temperature from about 40 degrees C. to about 120 degrees C. for from about 30 seconds to about 2 minutes. For example, the pre-curing may be performed at from about 50 degree C. to about 90 degrees C. for about 70 seconds.

In the pre-curing step, micro-phase separation of the alignment solution occurs, and the alignment solution is separated into a main layer and an alignment forming layer. The micro-phase separation may be generated when mixing two or more polymers having different physical properties by the gathering phenomenon of materials having similar physical properties in flowing conditions. For example, when solvents are removed, polymers included in the solvents may flow. In this case, the hydrophobic polymers may gather together, and the hydrophilic polymers may gather together. According to the micro-phase separation, the polymer included by smaller amounts among the two polymers may form domains in the remaining polymer. However, the two kinds of the polymers are not always completely phase separated, and each domain may become a region including one polymer in higher concentration than the other polymer. In an embodiment of the inventive concept, each domain corresponds to a reactive mesogen-rich area.

The phase separation phenomenon of the polymer and the shape of each domain may be controlled by the component ratio of the mixed composition of the two polymers, the molecular weight of each polymer, the solvent used in the mixture, the temperature during the phase separation, the solubility of each polymer, the polymer dispersity index of each polymer, and the like. With respect to the alignment solution, the alignment forming layer may be formed according to a growing process after forming a core.

As a result, the polymer for the main layer including the vertical alignment group and the polymer for forming the alignment forming layer including the second and the vertical alignment group have different physical properties, particularly different hydrophobicity, and may be separated sequentially. Thus, a main layer including a relatively hydrophilic polymer compound and an alignment forming layer including a relatively hydrophobic polymer compound are formed.

Then, the main layer and the alignment forming layer may be formed by performing a main curing (Step S30).

During the main curing step, the reaction between the cross-linking agent and each polymer is terminated, and the remaining solvents not removed at the pre-curing step may be removed. The main curing may be performed at a temperature from about 180 degrees C. to about 250 degrees C. for about 10 minutes to about 20 minutes. For example, the main curing may be performed at from about 200 degrees C. to about 220 degrees C. for about 15 minutes.

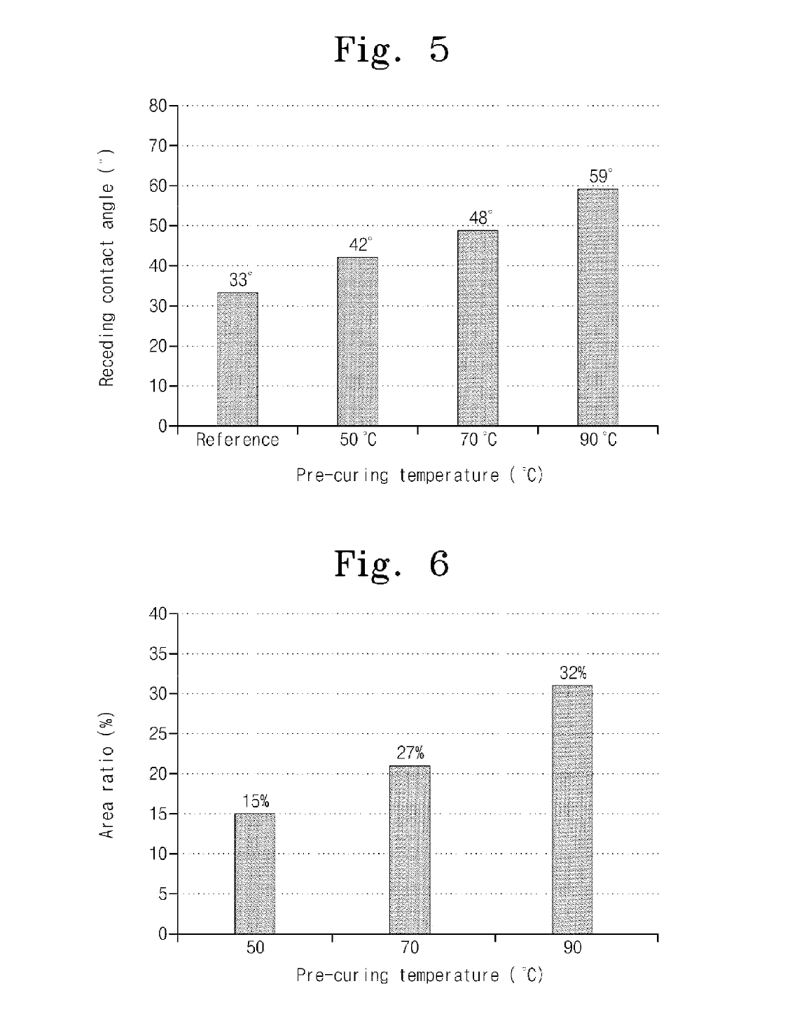

FIG. 5. is a section view of the result of the method shown in FIG. 4 including vertical alignment group VAG, reactive mesogen group RMG and initial alignment layer IAL. Initial alignment layer IAL includes main layer ML and alignment forming layer PFL.

Referring to FIG. 3 again, the first substrate and the second substrate are disposed facing each other, and the first initial alignment layer and the second initial alignment layer are disposed facing each other. The distance between the first initial alignment layer and the second initial alignment layer, that is, a cell gap, may be determined according to the structure of pixels and may be formed to about 3 μm in an embodiment of the inventive concept. Between the first initial alignment layer and the second initial alignment layer, a liquid crystal layer may be formed (Step S150). The method of forming the liquid crystal layer is not limited specifically and may be formed by, for example, a one drop filling (ODF) method.

Next, the first initial alignment layer and the second initial alignment layer may be exposed to an electric field (Step S160). An electric field may be formed between the first electrode and the second electrode, and the electric field may be formed by applying different voltages to the first electrode and the second electrode (Step S161). In addition, first light (for example, ultraviolet light) is applied to the first initial alignment layer and the second initial alignment layer while applying the electric field to the liquid crystal composition to perform first curing (Step S162). The electric field and the first light may be provided so as to drive the liquid crystal molecules and to cause the polymerization reaction of the reactive mesogen, and the ranges thereof are not limited specifically. For example, the electric field may be applied in a range of about 9 V to about 40 V, and the first light may be provided in an energy level from about 5 to about 15 J. In another embodiment of the inventive concept, the electric field may be applied at about 20 V, and the energy level of the first light may be about 6 J.

The reactive mesogens of the first initial alignment layer and the second alignment layer may perform a reaction induced by the first light. More particularly, each of the reactive mesogen in the alignment forming layer of the first initial alignment layer and the reactive mesogen in the alignment forming layer of the second initial alignment layer induces the polymerization reaction, and a network between the reactive mesogens is formed. Here, since the reactive mesogen forms the network while the liquid crystal molecules are aligned by the electric field, the network has specific directional properties along the mean alignment direction of the liquid crystal molecules. Thus, the liquid crystal molecules adjacent to the network may have a pretilt angle even when the electric field is inactive.

Then, second light (for example, ultraviolet light) is applied to the first initial alignment layer and the second initial alignment layer while removing the electric field to perform second curing (Step S170). The second light may have different wavelengths from the first light, for example, shorter wavelengths. The second curing may be performed by providing the second light for less than or equal to about 120 minutes. During the second curing process, the remaining reactive mesogen unreacted during the first curing may be polymerized.

In the liquid crystal display device having the above-described structure, the reactive mesogen provided in the alignment forming layer may easily pretilt the liquid crystal molecules. The pretilt angle of the liquid crystal molecules may be controlled by changing the shape and the forming method of the alignment forming layer. For example, the pretilt angle may be controlled by the component ratio of the mixed composition of the polymers, the molecular weight of each polymer, the type and the amount of the solvents in the mixed composition, the temperature during the phase separation, the solubility of each polymer, the polymer dispersity index of each polymer, and the like.

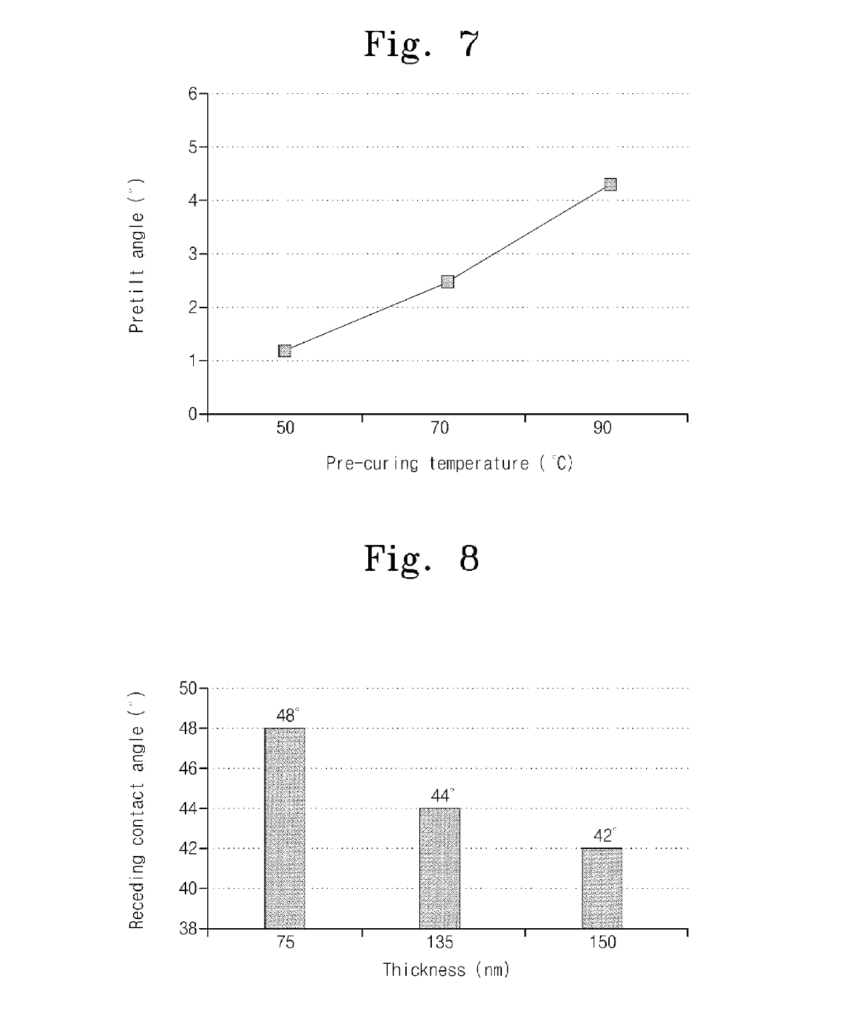

FIG. 5 is a graph illustrating receding contact angles of an initial alignment layer with respect to pre-curing temperatures. FIG. 6 is a graph illustrating area ratios of an alignment forming layer with respect to pre-curing temperatures. FIG. 7 is a graph illustrating pretilt angles with respect to pre-curing temperatures.

In FIG. 5, the portion designated by “reference” corresponds to a case when an initial alignment layer is formed by using an alignment solution having only vertical alignment groups. Substantially the same interface may be formed as the surface of the main layer. In FIGS. 6 to 8, the portions designated by temperatures correspond to cases when the pre-curing was performed using the alignment solution according to an embodiment of the inventive concept. Here, all of the conditions other than the pre-curing temperature were the same. In FIG. 6, the area ratio of the alignment forming layer means an area occupied by the alignment forming layer in an alignment layer in a specific unit area on a plane. In FIG. 7, the pretilt angle means the pretilt angle of liquid crystal molecules and means an inclined angle with respect to the surface of the first or the second substrate to a vertical direction.

Referring to FIGS. 5 and 6, the receding contact angle and the area ratio of the alignment forming layer may increase when the pre-curing temperature increases. As the pre-curing temperature increases, the assembling degree of the hydrophilic materials and the hydrophobic materials also may increase, and the micro-phase separation degree in the alignment solution may increase. In addition, as the area ratio of the domain increases, the pretilt angle also increases.

Through FIGS. 5 to 7, it may be confirmed that the pretilt angle of the liquid crystal molecules may be controlled by controlling the area ratio of the alignment forming layer, and the area ratio may be controlled by controlling the pre-curing temperature.

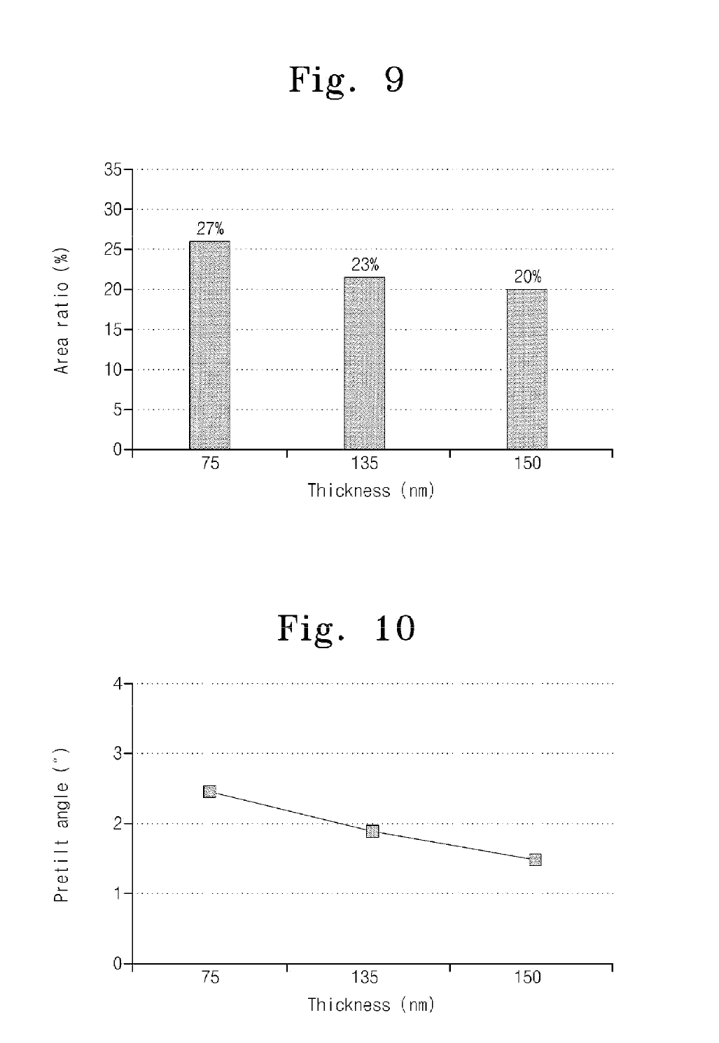

FIG. 8 is a graph illustrating the receding contact angles of initial alignment layers with respect to the formed thicknesses of the initial alignment layers. FIG. 9 is a graph illustrating the area ratios of a domain with respect to the thicknesses of initial alignment layers. FIG. 10 is a graph illustrating pretilt angles with respect to the thicknesses of initial alignment layers.

In exemplary embodiments of FIGS. 8 to 10, all of the conditions other than the thickness of the initial alignment layer were kept the same.

Referring to FIGS. 8 to 10, as the thickness of the initial alignment layer thus formed increases, the receding contact angle decreases, the area ratio of the domain decreases, and the pretilt angle also decreases. When the formed thickness of the alignment solution increases, the removal of solvents may be more difficult and the assembling of specific polymers in the initial alignment layer may also be more difficult. As a result, the area ratio of the alignment forming layer decreases, and the pretilt angle of the liquid crystal molecules according to the reactive mesogen also decreases.

Through FIGS. 8 to 10, it would be confirmed that the pretilt angle of the liquid crystal molecules may be controlled by controlling the area ratio of the alignment forming layer, and the area ratio may be controlled by controlling the thickness of the initial alignment layer.

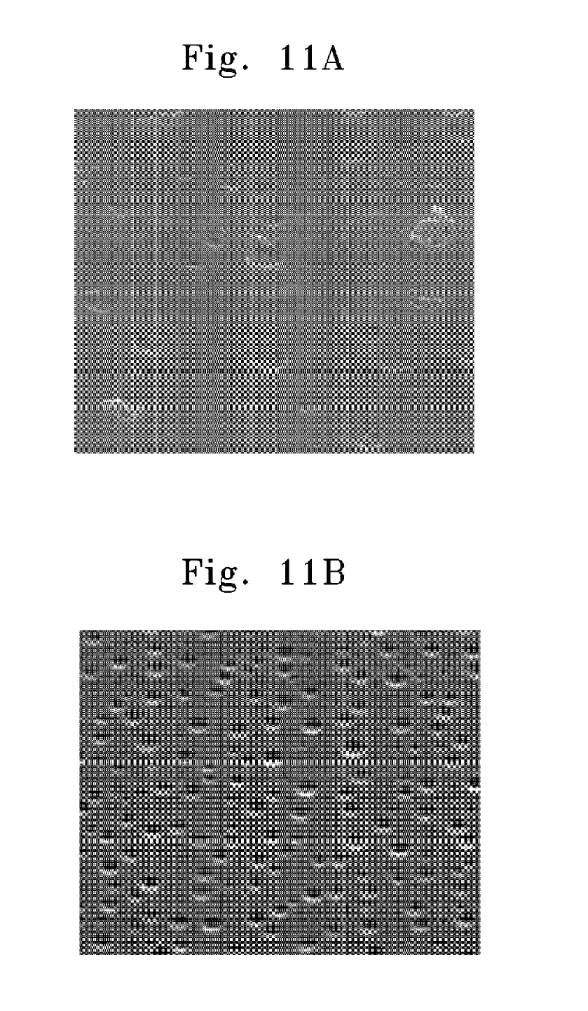

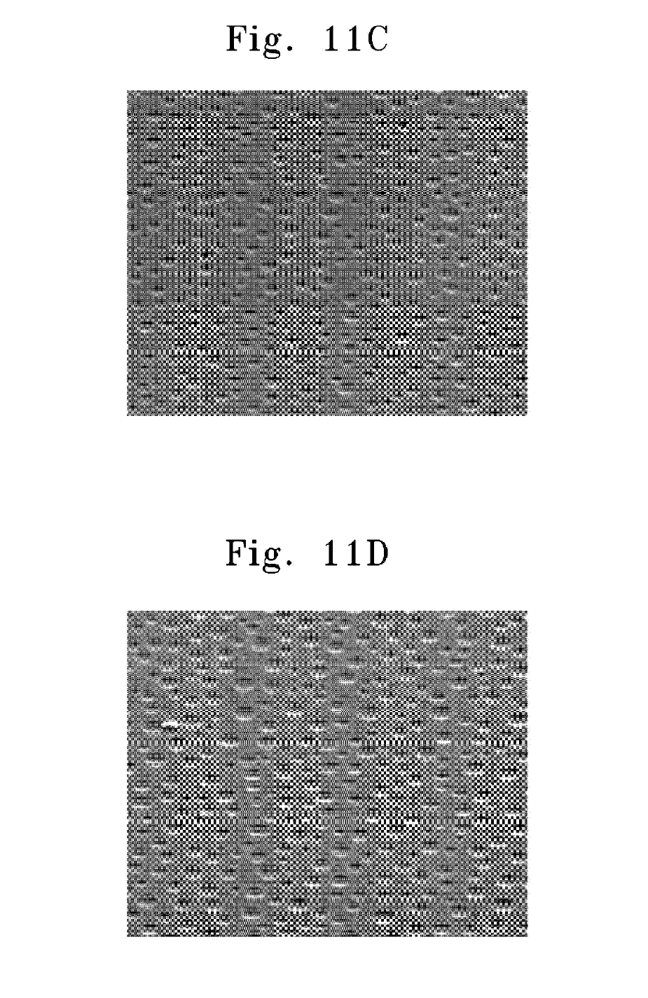

FIGS. 11A to 11D are photographs of alignment layers formed with different areas of alignment forming layers, respectively. In FIGS. 11A to 11D, alignment forming layers having different areas were formed by using the same alignment layer however changing the pre-curing temperature. In these examples, an alignment solution including about 3 wt % of a solid content and about 97 wt % of a solvent was used. Here, the solid content included about 85 wt % of a polymer for forming a main layer, about 8.3 wt % of a polymer for forming an alignment forming layer, and about 6.2 wt % of an epoxy-based cross-linking agent based on the total weight of the solid content. In addition, the solvent included about 55 wt % of butyl cellosolve and about 45 wt % of N-methyl pyrrolidone.

Referring to FIGS. 11A to 11D, alignment layers having different areas of the alignment forming layers may be formed as illustrated in the drawings. The area ratios of the alignment forming layers measured in FIGS. 11A to 11D were about 6.1% in FIG. 11A, about 17.4% in FIG. 11B, about 27.5% in FIG. 11C and about 38.6% in FIG. 11D. In addition, the pretilt angles of the liquid crystal molecules in liquid crystal display devices using the alignment layers illustrated in FIGS. 11A to 11D were measured and were about 0.54 degrees in the alignment layer of FIG. 11A, about 1.7 degrees in the alignment layer of FIG. 11B, about 2.9 degrees in the alignment layer of FIG. 11C and about 4.8 degrees in the alignment layer of FIG. 11D.

As described above, the alignment forming layer may be formed by using the micro-phase separation, and the pretilt angle of the liquid crystal molecules may be controlled according to the area of the alignment forming layer.

The above-disclosed subject matter is to be considered illustrative and not restrictive, and the appended claims are intended to cover all such modifications, enhancements, and other embodiments, which fall within the true spirit and scope of the inventive concept.

Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A liquid crystal display device, comprising:
two opposing substrates;
a liquid crystal layer disposed between the substrates; and
an alignment layer disposed between the liquid crystal layer at least one each of the substrates, the alignment layer comprising:
a main layer; and
an alignment forming layer disposed on the main layer and comprising domains phase-separated from the main layer.

2. The liquid crystal display device of claim 1, wherein the alignment forming layer is more hydrophobic than the main layer.

3. The liquid crystal display device of claim 1, wherein the alignment forming layer comprises a polymerized reactive mesogen.

4. The liquid crystal display device of claim 3, wherein a region where the alignment forming layer comprises a higher mesogen concentration than the main layer.

5. The liquid crystal display device of claim 4, wherein:
an inner surface of the alignment layer faces the liquid crystal layer; and
the alignment forming layer forms at least 5% of the inner surface of the alignment layer.

6. The liquid crystal display device of claim 3, wherein the reactive mesogen comprises at least one selected from an acrylate group, an epoxy group, an oxetane group, a vinyl-ether group, a styrene group, and a thiolane group.

7. The liquid crystal display device of claim 3, wherein the main layer comprises at least one selected from a polyimide, a polyamic acid, a polyamide, a polyamic imide, a polyester, a polyethylene, a polyurethane, and a polystyrene.

8. The liquid crystal display device of claim 3, wherein the alignment layer comprises a vertical alignment group configured to vertically align liquid crystal molecules.

9. The liquid crystal display device of claim 8, wherein the vertical alignment group comprises at least one selected from an alkoxy group including an aliphatic alkyl group having 1 to 25 carbon atoms, a cholesteric group, an alicyclic group including an aliphatic alkyl group having 1 to 10 carbon atoms, and an aromatic group including an aliphatic alkyl group having 1 to 10 carbon atoms.

10. The liquid crystal display device of claim 1, wherein a mean diameter of each domain is less than or equal to 400 nm.

11. The liquid crystal display device of claim 1, wherein each of the domains comprises an elliptical shape.

12. A method for manufacturing a liquid crystal display device, the method comprising:
disposing a liquid crystal layer between two substrates, each substrate comprising an initial alignment layer; and
performing a first exposure process to form an alignment layer, by applying an electric field and first light to the initial alignment layer,
wherein forming of the initial alignment layer on each substrate comprises:
coating an alignment solution on a substrate;
pre-curing the alignment solution to form a main layer, and an alignment forming layer disposed on the main layer comprising a plurality of domains phase separated from the main layer; and
main curing the main layer and the alignment forming layer.

13. The method for manufacturing a liquid crystal display device of claim 12, wherein the alignment solution comprises:
a solvent; and
a polymer disposed in the solvent and comprising a vertical alignment group and a reactive mesogen.

14. The method for manufacturing a liquid crystal display device of claim 13, wherein the polymer comprises at least one among polyimide, polyamic acid, polyamide, polyamic imide, polyester, polyethylene, polyurethane, and polystyrene.

15. The method for manufacturing a liquid crystal display device of claim 13, wherein the vertical alignment group is at least one selected from an alkoxy group including an aliphatic alkyl group having 1 to 25 carbon atoms, a cholesteric group, an alicyclic group including an aliphatic alkyl group having 1 to 10 carbon atoms, and an aromatic group including an aliphatic alkyl group having 1 to 10 carbon atoms.

16. The method for manufacturing a liquid crystal display device of claim 13, wherein the reactive mesogen comprises at least one selected from an acrylate group, an epoxy group, an oxetane group, a vinyl-ether group, a styrene group, and a thiolane group.

17. The method for manufacturing a liquid crystal display device of claim 13, wherein removing at least a portion of the solvent, causing a micro-phase separation of a portion of the alignment solution, forms the main layer and the alignment forming layer.

18. The method for manufacturing a liquid crystal display device of claim 17, wherein a region where the alignment forming layer comprises a higher mesogen concentration than the main layer.

19. The method for manufacturing a liquid crystal display device of claim 18, wherein the reactive mesogen is polymerized by the first exposing.

20. The method for manufacturing a liquid crystal display device of claim 12, further comprising second exposing the initial alignment layer with second light having a shorter wavelength than the first light without applying the electric field.
